(19) United States
(12) Patent Application Publication
(10) Pub. No.: US 2007/0284770 A1
(43) Pub. Date: Dec. 13, 2007

(54) Decreased lens delamination during ophthalmic lens manufacture

(76) Inventors: Scott F. Ansell, Jacksonville, FL (US); Gregory Berckmiller, Jacksonville, FL (US); Richard Fox, Jacksonville, FL (US); Mike J. Strong, Jacksonville, FL (US); Jason Tokarski, Jacksonville, FL (US); Craig W. Walker, Jacksonville, FL (US); Changhong Yin, Augustine, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/448,360

(22) Filed: Jun. 7, 2006

(51) Int. Cl. B02B 1/04

(52) U.S. Cl. 264/2.6; 425/175

(57) ABSTRACT

The present invention includes molds for forming ophthalmic lenses, such as contact lens. In particular, the present invention relates to apparatus, molds and methods for fashioning an ophthalmic lens with a mold assembly that includes a two or more mold parts and an adhesion differential between a surface of each mold part in the lens forming area as the surface relates to the ophthalmic lens.

### FIELD OF THE INVENTION

This invention relates to molds for forming an ophthalmic lens. More specifically, the present invention relates to apparatus and methods for fashioning an ophthalmic lens with a mold assembly that includes a two or more mold parts with a surface adhesion differential in the lens forming area.

### BACKGROUND OF THE INVENTION

It is well known that contact lenses can be used to improve vision. Various contact lenses have been commercially produced for many years. Early designs of contact lenses were fashioned from hard materials. Although these lenses are still currently used in some applications, they are not suitable for all patients due to their poor comfort and relatively low permeability to oxygen. Later developments in the field gave rise to soft contact lenses, based upon hydrogels.

Hydrogel contact lenses are very popular today. These lenses are often more comfortable to wear than contact lenses made of hard materials. Soft contact lenses can be manufactured by forming a lens in a multi-part mold where the combined parts form a topography consistent with the desired final lens.

Ophthalmic lenses are often made by cast molding, in which a monomer material is deposited in a cavity defined between optical surfaces of opposing mold parts. Multi-part molds used to fashion hydrogels into a useful article, such as an ophthalmic lens, can include for example, a first mold part with a convex portion that corresponds with a back curve of an ophthalmic lens and a second mold part with a concave portion that corresponds with a front curve of the ophthalmic lens. It is to be understood that unless specifically indicated otherwise, a first mold part can also include front curve mold part wherein the second mold part will therefore comprise a back curve mold part.

To prepare a lens using such mold parts, an uncured hydrogel lens formulation is placed between the concave and convex surfaces of the mold portions and subsequently cured. The hydrogel lens formulation may be cured, for example by exposure to either, or both, heat and light. The cured hydrogel forms a lens according to the dimensions of the mold portions.

Following cure, traditional practice dictates that the mold portions are separated and the lens remains adhered to one of the mold portions. A release process detaches the lens from the remaining mold part.

Further, new developments in the field have led to contact lenses made from hydrogels and silicone hydrogels that are coated with polymers to improve the comfort of the lenses. Often lenses are coated by treating the cured lenses with a polymer. Recently polymer coated lenses have been produced by coating the surfaces of a two part mold with a polymer, adding an uncured formulation to the coated lens mold, curing the lens, and subsequently releasing the cured lens from the mold where the surface of said cured lens is coated with the polymer that was originally adhered to the surface of the mold

It is known that some mold materials provide certain characteristics to a mold part which may be desirable, such as modulus qualities, while other mold materials may provide certain characteristics which are desirable for a mold surface, such as surface properties. Heretofore, a mold designer may have had to choose between different qualities in a single plastic injection molding environment or attempt to create a mold par through expensive, complicated and relatively slow co-injection molding processes.

Therefore, it would be advantageous to provide apparatus and methods which facilitate the use of a mold part with desirable characteristics from more than one mold material and to be able to create such a mold part using single unit injection molding processes.

### SUMMARY OF THE INVENTION

Accordingly, the present invention provides methods and apparatus for decreasing the incidence of lens delamination during lens manufacture. Embodiments can include a mold assembly that includes a first mold part with a first lens forming surface and with a first adhesive force in relation to an ophthalmic lens formed in contact with the first lens forming surface. In addition, a second mold part can include a second lens forming surface with a second adhesive force in relation to the ophthalmic lens which is additionally formed in contact with the second lens forming surface. A bias will exist between the first adhesive force and the second adhesive force. For example, in some embodiments, the first adhesive force in relation to the ophthalmic lens is greater than the second adhesive force in relation to the ophthalmic lens. the difference in first adhesive force and the second adhesive force is sufficient to cause the ophthalmic lens to remain adhered to the first lens forming surface following separation of the second mold part from the first mold part during lens manufacture.

Adhesive force differential can be accomplished, for example, with mold parts, such a front curve mold part and a back curve mold part made up of dissimilar mold materials. Some preferred embodiments can therefore include a first mold part fashioned from polystyrene and a second mold part fashioned from polypropylene. Some embodiments can also include mold parts fashioned from a cyclic olefin copolymer (also referred to as “COC”). A bias differential can also be accomplished by utilizing mold parts of similar material wherein one or both mold parts additionally includes an additive.

In another aspect, the present invention can include methods of molding an ophthalmic lens by dosing a reaction mixture into a first mold part and coupling a second mold part to the first mold part to form a cavity therebetween. The reaction mixture will be formed to a shape of the cavity. The reaction mixture can be exposed to actinic radiation thereby forming an ophthalmic lens. According to the present invention, the second mold part is separated from the first mold part and the ophthalmic lens, wherein the second mold part comprises an adhesive force in relation to the ophthalmic lens that is less than the adhesive force of the firs mold part in relation to the ophthalmic lens. The ophthalmic lens can be automatically inspected for delamination with a determination that less than threshold incidence of delamination occurred. Threshold incidence can include, for example, less than 2% in some preferred embodiments, or less than 10% or 20% in other embodiments.

### DESCRIPTION OF THE DRAWINGS

FIG. 1 illustrates a diagram of an ophthalmic lens mold and lens with a delamination point.

FIG. 2 illustrates a block diagram of method steps that can be used to implement the present invention.

FIG. 3 illustrates a block diagram of apparatus that can be used to implement the present invention.

FIG. 4 illustrates a view of delaminated portions of an ophthalmic lens as they may be ascertained by an automatic lens inspection system.

### DETAILED DESCRIPTION OF THE INVENTION

The present invention relates generally to methods for reducing lens delamination during manufacturing of ophthalmic lenses. In particular, the present invention refers to the use of two mold parts, such as a base curve mold part and a front curve mold part, each with a lens forming surface, wherein an adhesive bias exists between an ophthalmic lens formed between the two lens forming surfaces in relation to the ophthalmic lens.

The presence of adhesive bias between base curve and front curve facilitates easier, reduced pry force disengagement/separation of the front curve mold parts and the base curve mold parts during lens demolding. Embodiments can include, for example, the adhesive bias being accomplished via: dissimilar mold materials; dissimilar mold surface materials, additives to the mold material of one or more mold parts, thermal energy differential between the mold parts and other means to impart a delta in adhesive force between the lens forming surface of a first mold part and the lens forming surface of a second mold part.

In some embodiments, dissimilar mold materials may include pure plastic resins or compounded resins blended with two or more materials and/or additives. Use of polypropylene base curve with polystyrene front curve allows for easy removal of the base curve without disturbing the lens.

In some preferred embodiments, dissimilar mold materials can include ExxonMobil PP9544MED® Polypropylene (9544) as base curve and NOVA Chemicals Polystyrene VEREX 1300® compounded with Zinc Stearate additive as front curve.

Alternate materials such as Zeonor and Zeonex by Zeon Chemical Corporation and polypropylene blends at variety of blending ratios can also be used, as can polyolefins, cyclic olefins and cyclic olefin copolymers, including, in some embodiments polyolefins and COCs compounded with additives. In some specific embodiments, examples can include, but are not limited to: PP9544 and polystyrene, 55% Zeonor and 45% polypropylene or polystyrene, 75% Zeonor and 25% polypropylene or polystyrene, 25% Zeonor and 75% polypropylene or polystyrene, 10% Zeonor and 90% polypropylene or polystyrene, 90% Zeonor and 10% polypropylene or polystyrene, 50% Zeonor and 50% polypropylene or polystyrene, and ExxonMobil PP 1654 E with the same above ratios.

These blended resins can be obtained using different compounding methods, including hand blending, single screw compounding, twin screw and/or multiple screw compounding.

Defined Terms

As used herein “lens” or “ophthalmic lens” refers to any ophthalmic device that resides in or on the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision.

As used herein, the term “lens forming mixture” refers to a prepolymer material which can be cured, to form an ophthalmic lens. Various embodiments can include prepolymer mixtures with one or more additives such as: UV blockers, tints, photoinitiators or catalysts, and other additives one might desire in an ophthalmic lenses such as, contact or intraocular lenses. Lens forming mixtures are more fully described below.

As used herein, the term “lens delamination” refers to partial separation of an ophthalmic lens from a first mold part used to form the lens following decoupling of the first mold part from a second mold part used to fashion the lens.

As used herein, the term “released from a mold,” refers to an ophthalmic lens that is either completely separated from a first mold part used to fashion the lens, or the ophthalmic lens is only loosely attached so that the lens can be removed with mild agitation or pushed off with a swab.

As used herein, the term “uncured” refers to the physical state of a Reaction Mixture (sometimes referred to as “lens formulation”) prior to final curing to form a lens. Some Reaction Mixtures contain mixtures of monomers which are cured only once. Other Reaction Mixtures contain monomers, partially cured monomers, macromers and other components.

As used herein the term “lens forming surface” means a surface 103-104 that is used to mold a lens. In some embodiments, any such surface 103-104 can have an optical quality surface finish, which indicates that it is sufficiently smooth and formed so that a lens surface fashioned by the polymerization of a lens forming material in contact with the molding surface is optically acceptable. Further, in some embodiments, the lens forming surface 103-104 can have a geometry that is necessary to impart to the lens surface the desired optical characteristics, including without limitation, spherical, aspherical and cylinder power, wave front aberration correction, corneal topography correction and the like as well as any combinations thereof.

As used herein, the term, “Reaction Mixture” can include any material or mixture of materials, which upon polymerization yields an optically clear, integral shape-sustaining ophthalmic lens or ophthalmic lens precursor.

Molds

As used here, the term “mold” refers to a rigid or semi-rigid object that may be used to form lenses from uncured formulations. The preferred molds are two part molds as described above, where either the front curve or the back curve of the mold is made of materials which have an adhesive bias between a first lens forming surface and a second lens forming surface.

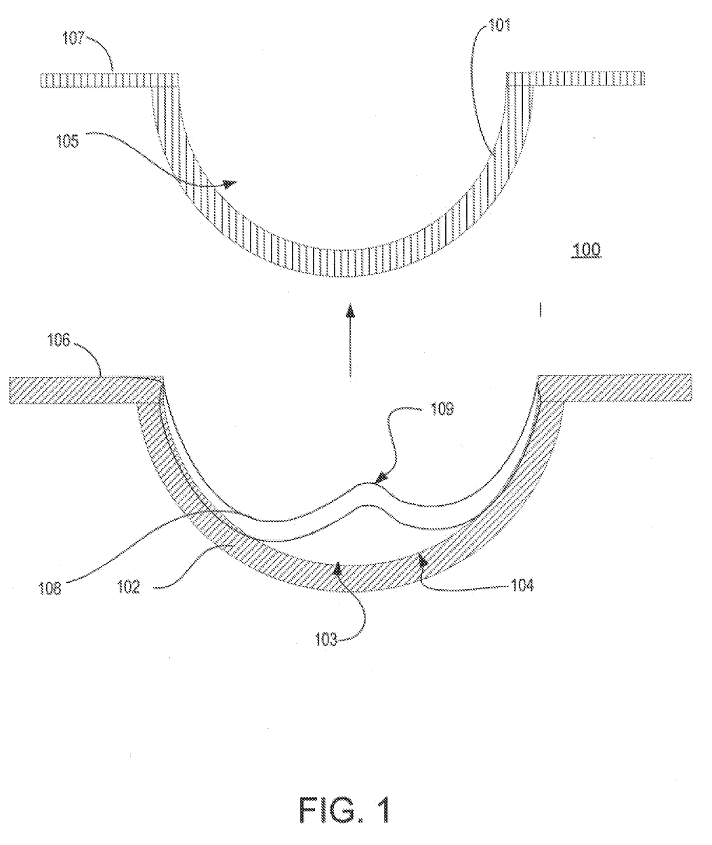

Referring now to FIG. 1, a diagram of an exemplary mold for an ophthalmic lens is illustrated. As used herein, the terms “mold” and “mold assembly” refer to a form 100 having a cavity 105 into which a lens forming mixture can be dispensed such that upon reaction or cure of the lens forming mixture, an ophthalmic lens 108 of a desired shape is produced. The molds and mold assemblies 100 of this invention are made up of two or more “mold parts” or “mold pieces” 101-102.

At least one mold part 101-102 is designed to have at least a portion of its surface 103-104 in contact with the lens forming mixture such that upon reaction or cure of the lens forming mixture that surface 103-104 provides a desired shape and form to the portion of the lens with which it is in contact. The same is true of at least one other mold part 101-102. The portion of the concave surface 104 which makes contact with reaction mixture has the curvature of the front curve of an ophthalmic lens to be produced in the mold assembly 100 and is sufficiently smooth and formed such that the surface of a ophthalmic lens formed by polymerization of the reaction mixture which is in contact with the concave surface 104 is optically acceptable.

Similarly, the back curve mold part 101 has a convex surface 103 in contact which contacts the lens forming mixture and has the curvature of the back curve of a ophthalmic lens to be produced in the mold assembly 100. The convex surface 103 is sufficiently smooth and formed such that the surface of a ophthalmic lens formed by reaction or cure of the lens forming mixture in contact with the back surface 103 is optically acceptable. Accordingly, the inner concave surface 104 of the front curve mold part 102 defines the outer surface of the ophthalmic lens, while the outer convex surface 103 of the back mold piece 101 defines the inner surface of the ophthalmic lens.

The mold parts 101-102 can be brought together, or “coupled”, such that a cavity is formed by combination of the mold parts 101-102 and a lens 108 can be fashioned in the cavity 105. This combination of mold parts 101-102 is preferably temporary. Upon formation of the lens, the mold parts 101-102 can again be separated for removal of a fashioned lens. FIG. 1 illustrates a back curve mold part 101 separated from a front curve mold part 102.

During separation, a delamination 109 can occur which partially separates the formed lens 108 from the front curve mold part 102. The present invention decreases or eliminates the incidence of lens delaminations 109.

According to the present invention, each mold part 101-102 has a different adhesive force present between the respective mold part and the formed lens therebetween. Embodiments can therefore include a back curve mold part 101 and a front curve mold part 102 with a bias of adhesive force between the lens 100 and one of the back curve mold part 101 and the front curve mold part 102. Some preferred embodiments include a polypropylene as the base curve and polystyrene as the front curve. Specifically, and as indicated above, some preferred embodiments can include a polypropylene as a base curve and polystyrene, such as NOVA Chemicals VEREX 1300 compounded with zinc stearate as an additive for the front curve mold part 102.

Adhesive force between a mold part 101-102 and the lens 100 can be determined using well known methods in the art, such as, via mechanical demold force measurements or by using contact angle measurements and plotting a contact angle indicating the surface energy for several liquids in order to extrapolate a line. Adhesion energy between a liquid and a solid can be calculated and predicted by measuring their disperse part surface tension or surface energy and polar part surface tension or surface energy.

Aside from a base material, such as COCs or alicyclic co-polymers, in some embodiments, the molds of the invention may contain additives that facilitate the separation of the lens forming surfaces, reduce the adhesion of the cured lens to the molding surface, or both. For example, additives such as metal or ammonium salts of stearic acid, amide waxes, polyethylene or polypropylene waxes, organic phosphate esters, glycerol esters or alcohol esters may be added to alicyclic co-polymers prior to curing said polymers to form a mold. Examples of such additives can include, but are not limited, to Dow Siloxane MB50-001 or 321 (a silicone dispersion), Nurcrel 535 & 932 (ethylene-methacrylic acid co-polymer resin Registry No. 25053-53-6), Erucamide (fatty acid amide Registry No. 112-84-5), Oleamide (fatty acid amide Registry No. 301-02-0), Mica (Registry No. 12001-26-2), Atmer 163 (fatty alkyl diethanolamine Registry No. 107043-84-5), Pluronic (polyoxypropylene-polyoxyethylene block co-polymer Registry No. 106392-12-5), Tetronic (alkyoxylated amine 110617-70-4), Flura (Registry No. 7681-49-4), calcium stearate, zinc stearate, Super-Floss anti block (slip/anti blocking agent, Registry No. 61790-53-2), Zeospheres anti-block (slip/anti blocking agent); Ampacet 40604 (fatty acid amide), Kemamide (fatty acid amide), Licowax fatty acid amide, Hypermer B246SF, XNAP, polyethylene glycol monolaurate (anti-stat) epoxidized soy bean oil, talc (hydrated Magnsium silicate), calcium carbonate, behenic acid, pentaerythritol tetrastearate, succinic acid, epolene E43-Wax, methyl cellulose, cocamide (anti-blocking agent Registry No. 61789-19-3), poly vinyl pyrrolidinone (360,000 MW) and the additives disclosed in U.S. Pat. No. 5,690,865 which is hereby incorporated by reference in its entirety. The preferred additives are polyvinyl pyrrolidinone, zinc stearate and glycerol mono stearate, where a weight percentage of additives based upon the total weight of the polymers is about 0.05 to about 10.0 weight percent, preferably about 0.05 to about 3.0, most preferably about 2.0 weight percent.

In some embodiments, in addition to additives, the separation of the lens from a lens forming surfaces may be facilitated by applying surfactants to the lens forming surfaces. Examples of suitable surfactants include Tween surfactants, particularly Tween 80 as described in U.S. Pat. No. 5,837,314 which is hereby incorporated by reference in its entirety and Span 80. Other examples of surfactants are disclosed in U.S. Pat. No. 5,264,161 which is hereby incorporated by reference in its entirety.

Still further, in some embodiments, the molds of the invention may contain other polymers such as polypropylene, polyethylene, polystyrene, polymethyl methacrylate, modified polyolefins containing an alicyclic moiety in the main chain and cyclic polyolefins, such as, for example Zeonor and EOD 00-11 by Atofina Corporation. For example, a blend of the alicyclic co-polymers and polypropylene (metallocene catalyst process with nucleation, such as ATOFINA EOD 00-11®) may be used, where the ratio by weight percentage of alicyclic co-polymer to polypropylene ranges from about 99:1, to about 20:80 respectively. This blend can be used on either or both mold halves, where it is preferred that this blend is used on the back curve and the front curve consists of the alicyclic co-polymers.

Adhesion bias between front curve mold parts 102 and back curve mold parts 101 can be important to reduction, or even elimination of contact lens defects such as edge chips, tears, holes, delamination pulls, optical distortion, surface marks and other physical aberrations which result from manufacturing process, such as demold.

The advantage of an adhesive bias between the front curve mold part and base curve mold part materials is that it addresses the root cause for lens delamination, wherein, the root cause includes an equally strong adhesive force between the cured lens material and both mold parts of similar material, such as, for example polystyrene. According to the present invention, without a bias in adhesive force between the lens and the front curve mold part and base curve mold part, there is little or no preference for which mold part (i.e. front curve mold part and base curve mold part) the lens will remain with throughout demold. The result of this situation is an increase in demold-related defects, such as delamination.

Utilizing mold part surfaces with different adhesive forces, such as those present with the use of dissimilar mold materials, facilitates easy disengagement of the mold components (front curve and base curve molds) during lens demolding by creating a bias in adhesive force between the lens and the mold parts. The result is that the lens remains with a predetermined mold part, such as, for example, the front curve mold part throughout demold process.

In some embodiments, mechanical apparatus useful for further enhancing an adhesive bias can also be utilized. Such mechanical apparatus can include, for example, demold IR heaters, laser demold, forced hot air demold and pre-chillers. However according to the present invention, mechanical processing alone will not sufficiently produce an adhesive bias and the bias exists according to the properties in the mold part surface itself, such as a bias that is present due to dissimilar mold materials or present due to additives added to one or both mold parts of similar material. Adhesive bias in the mold part surface provides the additional advantage of reducing the criticality and complexity of such ancillary mechanical apparatus and means of enhancing adhesive bias. The elimination or reduced criticality of these mechanical processing aids/equipment allows for faster lens processing speeds and therefore greater throughput while maintaining high quality lenses and yields.

In some embodiments, one or both of the first mold part 102 and the second mold part 101 may also include multiple layers, and each layer may have different chemical structures. For example, a front curve mold part 102 may include a surface layer and a core layer, (not illustrated) such that the core layer includes the first material and the second material and is essentially covered by the first layer. At any given cross section, a concentration of the first material present in the surface layer is greater than the concentration of the first material present in the core layer. To continue with the example, according to the present invention, the surface layer will have an adhesive bias in relation to the lens as compared to the surface of the back curve mold part 101.

In some embodiments, it may also be possible that after a lens hydration process, some demolded lenses with delamination will fully recover to the lenses' predetermined shape, and may therefore no longer be considered defective. As a result, lens delamination occurring during the demolding could cause significant amount of false rejects by automatic lens inspection systems.

### Method Steps

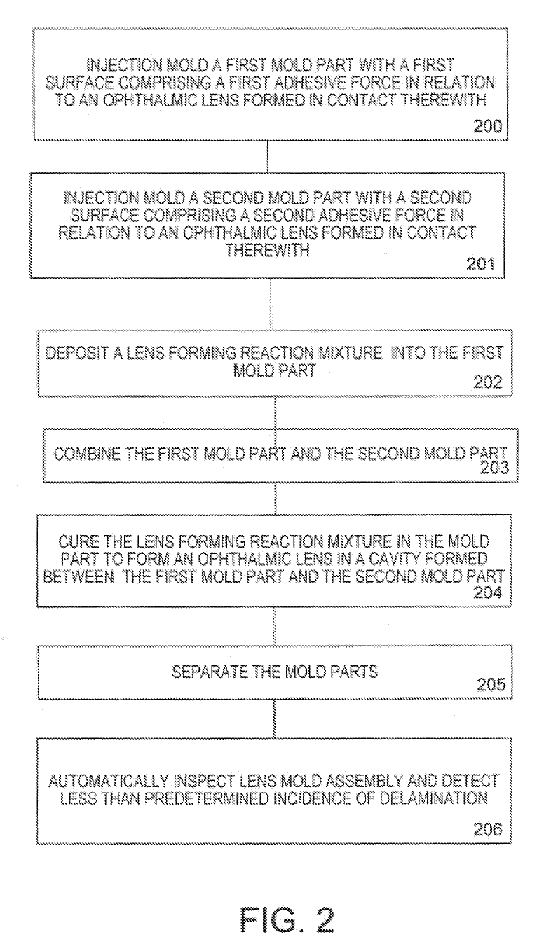

Referring now to FIG. 2, a flow diagram illustrates exemplary steps that may be implemented in some embodiments of the present invention. It is to be understood that some or all of the following steps may be implemented in various embodiments of the present invention.

At 200, the Reaction Mixture is deposited into a first mold part 102, which is utilized to shape the ophthalmic lens 100. The first mold part includes a first surface that has a first adhesive force in relation to an ophthalmic lens formed in contact with the surface layer.

At 201, the Reaction Mixture is deposited into a second mold part 101, which is utilized to shape the ophthalmic lens 108. The second mold part 101 includes a second surface that has a second adhesive force in relation to the ophthalmic lens 108 formed in contact with the second surface.

At 202, a lens forming Reaction Mixture is deposited into the first mold part, and at 203, the first mold part 102 can be combined with at least one other mold part (the second mold part) 101 to shape the deposited uncured monomer or prepolymer or other Reaction Mixture.

At 204, the Reaction Mixture is cured and formed into a lens 108. Curing can be effected, for example, by various means known in the art, such as, exposure of the monomer to actinic radiation, exposure of the monomer to elevated heat (i.e. 40° C. to 75° C.), or exposure to both actinic radiation and elevated heat.

At 205, the first mold part 102 can be separated from the second mold part 101 in a demolding process. In some embodiments, the lens 108 will have adhered to the first mold part 102 (i.e. the front curve mold part) during the cure process and remain with the second mold part 101 after separation until the lens 108 has been released from the front curve mold part 102. In other embodiments, the lens 108 can adhere to the second mold part 101.

At 206, automatic lens inspection (sometimes referred to as, “ALI”) equipment can be used to inspect the lens and determined if the lens is defective. According to the present invention, the ALI equipment will determine if a lens delamination has occurred. The incidence of delamination can thereby be determined and it can additionally be ascertained whether a predetermined incidence, such as, for example, less than 2% or less than 10% or less than 20% has been achieved. The ALI can include, for example, a camera which feeds images of the lenses and mold parts into a computer. The computer can analyze images of the lenses and mold parts to determine if a lens delamination is present. Other embodiments can also use ALI to ascertain lens tears which may result from lens demold or lens part separation.

### Apparatus

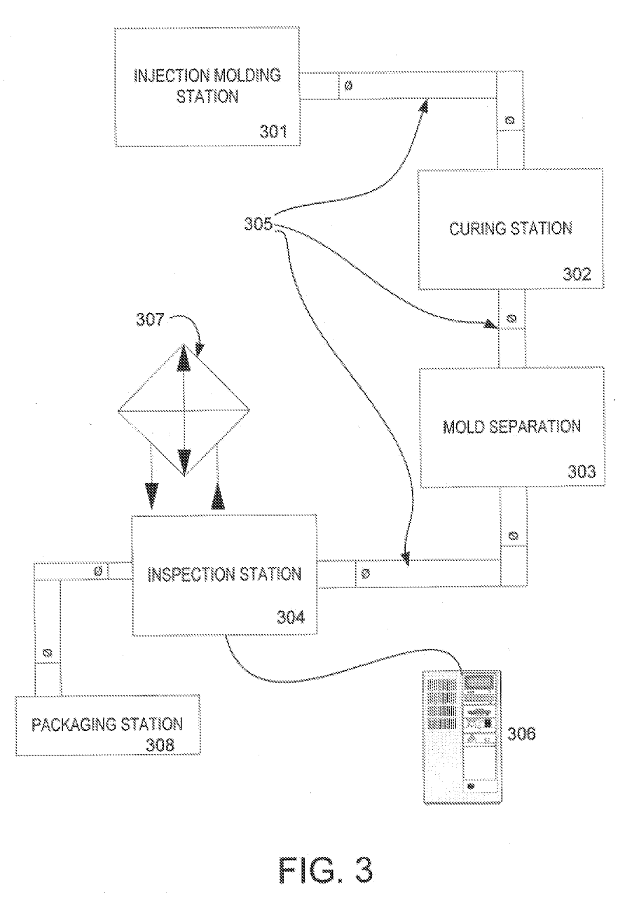

Referring now to FIG. 3, a block diagram is illustrated of apparatus contained in processing stations 301-304 that can be utilized in implementations of the present invention. In some preferred embodiments, processing stations 301-304 can be accessible to ophthalmic lenses 100 via a transport mechanism 305. The transport mechanism 305 can include for example one or more of: a robot, a conveyor and a rail system in conjunction with a locomotion means that may include, a conveyor belt, chain, cable or hydraulic mechanism powered by a variable speed motor or other known drive mechanism (not shown).

Some embodiments can include back surface mold parts 101 placed in pallets (not shown). The pallets can be moved by the transport mechanism 305 between two or more processing stations 301-304. A computer or other controller 306 can be operatively connected to the processing stations 301-304 to monitor and control processes at each station 301-304 and also monitor and control the transport mechanism 305 to coordinate the movement of lenses between the process stations 301-304.

Processing stations 301-304 can include, for example, an injection molding station 301. At the injection molding station 301, injection molding apparatus deposits a quantity of a Reaction Mixture, such as, for example, a silicone hydrogel, into the front curve mold portion 102 and preferably completely covers the mold surface 104 with the Reaction Mixture.

As utilized in this application, a “precursor” means an object which has the desired relative dimensions and which upon subsequent hydration in water or buffered isotonic saline aqueous solution can be worn as a contact lens. Examples of such compositions abound in this field and are readily ascertainable by reference to standard literature sources.

In some embodiments, polymerization of Reaction Mixture can be carried out in an atmosphere with controlled exposure to oxygen, including, in some embodiments, an oxygen-free environment, because oxygen can enter into side reactions which may affect a desired optical quality, as well as the clarity of the polymerized lens. In some embodiments, the lens mold halves are also prepared in an atmosphere that has limited oxygen or is oxygen-free. Methods and apparatus for controlling exposure to oxygen are well known in the art.

A curing station 302 can include apparatus for polymerizing the Reaction Mixture. Polymerization is preferably carried out by exposing the Reaction Mixture to a source of initiation which can include for example, one or more of: actinic radiation and heat. Curing station 302 therefore includes apparatus that provide a source of initiation of the Reaction Mixture deposited into the front curve mold 102. In some embodiments, actinic radiation can be sourced from bulbs under which the mold assemblies travel. The bulbs can provide an intensity of actinic radiation in a given plane parallel to the axis of the bulb that is sufficient to initiate polymerization.

In some embodiments, a curing station 302 heat source can be effective to raise the temperature of the Reactive Mixture to a temperature sufficient to assist the propagation of the polymerization and to counteract the tendency of the Reaction Mixture to shrink during the period that it is exposed to the actinic radiation and thereby promote improved polymerization. Some embodiments can therefore include a heat source that can maintain the temperature of the Reaction Mixture (by which is meant that resin before it begins to polymerize, and as it is polymerizing) above the glass transition temperature of the polymerized product or above its softening temperature as it is polymerizing. Such temperature can vary with the identity and amount of the components in the Reaction Mixture. In general, some embodiments include apparatus capable of establishing and maintaining temperatures on the order of 40° C. degree to 75° C.

In some embodiments, a source of heat can include a duct, which blows warm gas, such as, for example, N₂ or air, across and around the mold assembly as it passes under the actinic radiation bulbs. The end of the duct can be fitted with a plurality of holes through which warm gas passes. Distributing the gas in this way helps achieve uniformity of temperature throughout the area under the housing. Uniform temperatures throughout the regions around the mold assemblies can facilitate more uniform polymerization.

A mold separation station 303 can include apparatus to separate the back curve mold part 101 from the front curve mold part 102. Separation can be accomplished for example with mechanical fingers and high speed robotic movement that pry the mold parts apart.

An automatic lens inspection station 304 can be utilized to determine whether a lens has become delaminated during demold, or mold separation. The automatic lens inspection station can include, for example, a camera which feeds images of the lenses and associated mold parts into a computer 306 for analysis.

### Lens Materials

In some embodiments, preferred lenses of the invention are soft contact lenses are made from silicone elastomers or hydrogels, which include but are not limited to silicone hydrogels, and fluorohydrogels. Soft contact lens formulations are disclosed in U.S. Pat. No. 5,710,302, EP 406161, JP 2000016905, U.S. Pat. No. 5,998,498, U.S. Pat. No. 6,087,415, U.S. Pat. No. 5,760,100, U.S. Pat. No. 5,776,999, U.S. Pat. No. 5,789,461, U.S. Pat. No. 5,849,811, and U.S. Pat. No. 5,965,631. Further polymers that may be used to form soft contact lenses are disclosed in the following U.S. Pat. Nos. 6,419,858; 6,308,314; and 6,416,690.

Other preferred embodiments of the resent invention can include lenses of etafilcon A, genfilcon A, lenefilcon A, polymacon, acquafilcon A, balafilcon A, lotrafilcon A, galyfilcon A, senofilcon A, silicone hydrogels, including for example, lenses described in U.S. Pat. No. 6,087,415, U.S. Pat. No. 5,760,100, U.S. Pat. No. 5,776,999, U.S. Pat. No. 5,789,461, U.S. Pat. No. 5,849,811, and U.S. Pat. No. 5,965,631. Other embodiments can include ophthalmic lenses made from prepolymers. These patents as well as all other patent disclosed in this application are hereby incorporated by reference in their entirety.

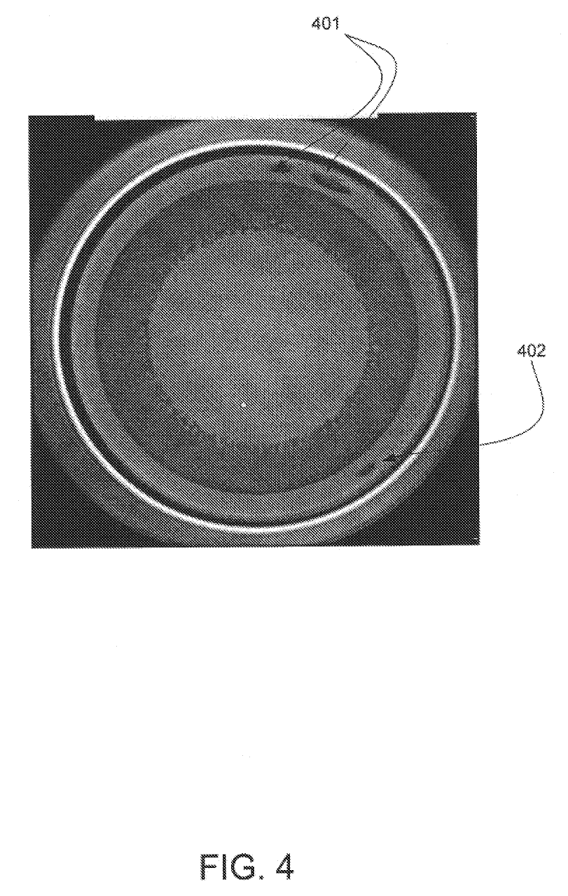

Referring now to FIG. 4, an illustration of a lens in a mold part is shown as it may be viewed by an automatic lens inspection system. Delaminations are indicated at 401 and 402. According to the present invention, use of mold parts with an adhesive bias in relation to the lens can limit such delamination indications to below a predetermined threshold, such as, for example below 2% of all lenses formed in a run, below 10% of all lenses formed in a run or below 20% of all lenses formed in a run. Other thresholds may also be set, are within the scope of the present invention, however, economic realities of a manufacturing environment dictate that higher thresholds are less desirable.

While the present invention has been particularly described above and drawings, it will be understood by those skilled in the art that the foregoing ad other changes in form and details may be made therein without departing from the spirit and scope of the invention, which should be limited only by the scope of the appended claims.

What is claimed is:

1. A mold assembly comprising;
a first mold part comprising a first lens forming surface with a first adhesive force in relation to an ophthalmic lens formed in contact with said first lens forming surface;
a second mold part comprising a second lens forming surface with a second adhesive force in relation to the ophthalmic lens which is additionally formed in contact with the second lens forming surface;
wherein the first adhesive force in relation to the ophthalmic lens is greater than the second adhesive force in relation to the ophthalmic lens and wherein the difference in first adhesive force and the second adhesive force is sufficient to cause the ophthalmic lens to remain adhered to the first lens forming surface following separation of the second mold part from the first mold part during lens formation.

2. The mold assembly of claim 1 wherein the a first lens forming surface additionally comprises a surface tension that is greater than the surface tension of the second lens forming surface.

3. The mold assembly of claim 1 wherein at least one of the mold parts comprises polypropylene.

4. The mold assembly of claim 1 wherein at least one of the mold parts comprises polystyrene.

5. The mold assembly of claim 1 wherein the first mold part and the second mold part comprises the same materials and at least one of the first mold part and the second mold part additionally comprises an additive.

6. The mold assembly of claim 1 wherein at least one of the mold parts comprises a cyclic olefin copolymer.

7. The mold assembly of claim 1 wherein the first mold part and the second mold part comprise different materials.

8. The mold assembly of claim 1 wherein at least one of the mold parts comprises a surface layer comprising a first material and a second material; and
a core layer comprising the first material and the second material and essentially covered by the first layer, wherein, at any given cross section, the amount of the first material present in the surface layer is greater than the amount of the first material present in the core layer.

9. The mold assembly of claim 8 wherein the first material comprises a lower surface energy than the second material.

10. The mold assembly of claim 8 wherein the first material comprises a higher surface energy than the second material.

11. The mold assembly of claim 8 wherein the first material comprises a higher modulus than the second material.

12. The mold assembly of claim 8 wherein the first material and the second material comprise at least two cyclic olefin copolymer of different chemical structures.

13. The mold assembly of claim 8 wherein the first material has a different melt flow index than the second material when subject to the conditions of an injection molding process used to fashion the mold part.

14. A method of molding an ophthalmic lens, the method comprising the steps of:
dosing a reaction mixture into a first mold part;
coupling a second mold part to the first mold part to form a cavity therebetween, with the reaction mixture formed to a shape of the cavity;
exposing the reaction mixture to actinic radiation thereby forming an ophthalmic lens;
separating the second mold part from the first mold part and the ophthalmic lens, wherein the second mold part comprises an adhesive force in relation to the ophthalmic lens that is less than the adhesive force of the firs mold part in relation to the ophthalmic lens;
automatically inspecting the lens for delamination from the first mold part; and
determining a less than 10% incidence of delamination of the lens from the first mold part following demold.

15. The method of claim 14 wherein at least one of the first mold part and the second mold part comprises an area capable of transmitting sufficient light energy to cure the reaction mixture.

16. The method of claim 12 wherein at least one of the first mold part and the second mold part comprises polyvinyl alcohol.

17. The method of claim 12 wherein at least one of the first mold part and the second mold part comprises polypropylene.

18. The method of claim 12 wherein the automatic lens inspection for delamination indicates a less than 2% incidence of ophthalmic lens delamination.

19. The method of claim 12 wherein the automatic lens inspection for delamination indicates a less than 20% incidence of ophthalmic lens delamination.

20. A method of molding an ophthalmic lens, the method comprising the steps of:
dosing a reaction mixture into a first mold part;
coupling a second mold part to the first mold part to form a cavity therebetween, with the reaction mixture formed to a shape of the cavity;
exposing the reaction mixture to actinic radiation thereby forming an ophthalmic lens;
separating the second mold part from the first mold part and the ophthalmic lens, wherein the second mold part comprises an adhesive force in relation to the ophthalmic lens that is less than the adhesive force of the first mold part in relation to the ophthalmic lens;
automatically inspecting the lens for tears; and
determining a less than 10% incidence of lens tears following demold.
